(19) United States
(12) Patent Application Publication
(10) Pub. No.: US 2012/0315594 A1
(43) Pub. Date: Dec. 13, 2012

(54) METHOD FOR PRODUCING AN ORTHODONTIC ELEMENT

(75) Inventors: Walter Ehrenberger, Kaempfelbach (DE); Michael Regelmann, Neulingen (DE); Michael Reise, Bretten (DE); Werner Ochs, Straubenhardt (DE)

(73) Assignee: DENTAURUM GmbH & Co. KG, Ispringen (DE)

(21) Appl. No.: 13/466,476

(22) Filed: May 8, 2012

Related U.S. Application Data
(63) Continuation of application No. PCT/EP2010/067144, filed on Nov. 9, 2010.

(30) Foreign Application Priority Data
Nov. 12, 2009 (DE) 10 2009 054 096.2

(51) Int. Cl. A61C 7/16

(52) U.S. Cl. 433/9

(57) ABSTRACT

The invention relates to a method for producing an orthodontic element with a ceramic main body, which has a base surface for fixing the element to a tooth. In order to develop the method in such a way that the main body can, on the one hand, be fastened to the tooth with a high adhesive force and, on the other hand, can easily be detached from the tooth at the end of an orthodontic treatment, it is proposed according to the invention that a laser beam is guided along the base surface in an impingement area, the base surface in the impingement area is superficially heated locally by means of the laser beam and microscopic particles are broken free from the base surface by means of crack development.

The invention relates to a method for producing an orthodontic element with a ceramic main body, which has a base surface for fixing the element on a tooth.

### BACKGROUND OF THE INVENTION

Orthodontic elements may, for example, be used in the course of an orthodontic treatment for correcting the faulty position of a tooth and may, for example, be configured in the form of a bracket or a buccal or lingual tube. In order to correct the faulty position of the tooth, the orthodontic element is fastened to the tooth. The main body may have a receiver, for example a slot or a cylindrical opening, a resilient arch wire being introduced into the receiver. Directing forces can then be exerted on the tooth by means of the arch wire, so that the position of said tooth on the jaw changes. To fix the orthodontic element on the tooth, an adhesive is used, with the aid of which the element can be temporarily fastened to the tooth enamel. On the one hand, this is to achieve an adequately stable fastening so that the desired directing forces can be exerted on the tooth. On the other hand, it has to be ensured that after the treatment has ended, the orthodontic element can be detached from the tooth with the tooth enamel as far as possible being undamaged.

The bonding between the orthodontic element and the adhesive and between the adhesive and the tooth may take place by means of a chemical bonding and/or by adhesion and may also be achieved by a mechanical interlocking. In the case of orthodontic elements with a metallic main body, it has proven to be advantageous to provide the base surface with a retention structure having a large number of indentations and/or elevations. This makes it possible to increase the surface areas of the parts to be glued to one another and thus improve the adhesive bond. The retention structure may, for example, have a net-like configuration, as described in DE 35 19 213 A1.

In the case of metallic main bodies and in general in main bodies made of a meltable material, it is known from EP 0 841 877 B1 to melt the base surface by means of laser beam in order to produce a large number of indentations and irregular elevations, which form undercuts and thereby allow an interlocking of the adhesive with the orthodontic element. Main bodies of this type are resiliently and/or plastically deformable.

Ceramic main bodies, in particular sintered ceramic main bodies, have practically no resilient or plastic deformability. Rather, they have a high degree of brittleness and also a very high melting temperature. They can therefore not be superficially melted by means of a laser beam. There is an actual danger, during melting, of the destruction of the main body. In order to nevertheless improve the bond between a ceramic main body and the tooth enamel, it is proposed in U.S. Pat. No. 5,197,873 to sinter a large number of very small particles on the base surface of the main body. As a result, the surface area of the main body cooperating with the adhesive is increased and, moreover, undercuts are provided which strengthen the mechanical bond between the adhesive and main body. U.S. Pat. No. 5,110,290 proposes applying a plastics material net to the ceramic main body. This also allows an increase in surface area and therefore a stronger connecting force between the adhesive and the main body. The sintering on of small particles, like the application of a plastics material net, has the drawback, however, that it impairs the biocompatibility, which is very good per se, of the ceramic main body material.

It was also proposed that the bond between the adhesive and a main body produced from aluminium oxide be improved by applying a silane layer. The silane layer brings about a strong chemical connection between the adhesive and the main body. However, there is a danger of the tooth enamel being damaged at the end of the orthodontic treatment when the orthodontic element is detached from the tooth. Moreover, the silane layer only has limited durability and the adhesive strength values exhibit a high variation. Moreover, considerable costs are linked with the application of a silane layer.

### BRIEF SUMMARY OF THE INVENTION

The object of the present invention is to provide a method of the above type for producing an orthodontic element, the main body of the element produced, on the one hand, being able to be fastened to the tooth with a high adhesive force and, on the other hand, being able to be easily separated from the tooth at the end of an orthodontic treatment.

This object is achieved according to the invention in a method of the type mentioned in the introduction in that a laser beam is guided along the base surface in an impingement area, the base surface in the impingement area is superficially heated locally by means of the laser beam and microscopic particles are broken free of the base surface by means of crack formation.

The invention also includes the idea that the interaction between the base surface of the main body and the adhesive can be considerably increased and thereby the adhesive force improved if the base surface has a roughened structure with a large number of fracture surfaces which are oriented obliquely with respect to one another. The microscopic fracture surfaces bring about a great surface area increase, wherein they are oriented in very different directions. The fracture surfaces are produced by the base surface being locally impinged upon by a laser beam in an impingement area, the base surface being superficially heated. As a result, cracks are induced in the brittle material of the main body in a region close to the surface, without the base surface being melted. Rather, thermal stresses are produced in a region of the main body close to the surface, so that fractures occur and microscopic particles are subtractively removed. As a result of this, a large number of microscopic fracture surfaces oriented obliquely with respect to one another form and result in a substantial increase in the surface area of the main body and lead to improved adhesive strength of the main body on the tooth to be treated. The region close to the surface may extend over a depth of less than 0.2 mm, preferably over a depth of less than 0.1 mm.

It has been shown that microscopic fracture surfaces, which are oriented obliquely with respect to one another, can easily be provided by the local superficial heating of the base surface by means of the laser beam and allow a high adhesive force between the orthodontic element and the tooth, the orthodontic element being able to be detached from the tooth without great difficulty at the end of an orthodontic treatment. The danger of damage to the tooth enamel on detachment of the orthodontic element is small.

The fracture surfaces produced by means of the laser beam by superficial crack formation preferably have a maximum extent of less than 50 μm, in particular less than 20 μm. The base surface of the ceramic main body therefore has a large number of relatively small fracture surfaces oriented obliquely with respect to one another. The smaller the fracture surfaces inclined at different angles with respect to one another in each case, the larger is the overall surface area, which is available for an interaction between the ceramic main body and the adhesive.

The fracture surfaces produced by the superficial heating by means of the laser beam are preferably at least partially flat.

By guiding the laser beam along the base surface, areas of the base surface are heated to a temperature below the melting temperature. As a result, thermal stresses are induced, which lead to a crack formation, so that microscopic particles break free from the base surface. The base surface therefore exhibits a large number of fracture surfaces oriented obliquely with respect to one another and therefore has a large surface area, so that a considerable adhesive strength can be achieved. The fracture surfaces may also thus form undercuts, which allow an interlocking of the adhesive with the base surface.

Owing to the laser-induced breaking free of microscopic particles and the configuration of fracture surfaces formed thereby in the base surface, adhesive strength values can be achieved for the bond of the main body and the adhesive that have a considerably lower variation than is the case in silanised base surfaces. Unacceptably high adhesive strength values can be avoided, and this in turn reduces the risk of the tooth enamel being damaged during the detachment of the orthodontic element from the tooth at the end of an orthodontic treatment.

The impingement area, in which the laser beam is guided along the base surface in order to locally heat it superficially, so that a large number of microscopic fracture surfaces oriented obliquely with respect to one another are produced by crack formation, may extend over the entire base surface. However, it may also be provided that the impingement area only extends over a part area of the base surface. A roughened structure forms in this part area owing to the laser impingement, whereas the base surface remains without roughening outside the impingement area.

The extent of the impingement area only over a part area of the base surface provides the possibility of providing the base surface outside the impingement area with a marking for allocation of the orthodontic element to a tooth type. The marking helps the orthodontist to allocate the orthodontic element to a specific tooth type. There can be used, for example, as the marking a tooth designation in the form of a numerical abbreviation according to the FDI system, in other words in accordance with the identification system of the Fédération Dentaire Internationale. The marking can be seen better outside the roughened structure produced by the laser impingement.

It may, for example, be provided that the edge of the impingement area defines the marking. In a configuration of this type, the impingement area is practically the negative of the marking, in other words the area of the base surface outside the impingement area already forms the marking, without additional treatment steps being necessary.

Alternatively, it may be provided that the marking only partially covers the area of the base surface outside the impingement area. In a configuration of this type, the marking is arranged in the area of the base surface outside the impingement area.

It may be provided that the marking is produced by a physical, chemical or mechanical additive and/or subtractive treatment of the base surface outside the roughened structure.

It is particularly advantageous if the marking is produced by means of a laser beam. It is advantageous for this if the laser beam is continuously moved at least over a portion of the base surface outside the impingement area, in which the roughened structure is located.

The laser beam advantageously being used to produce the marking preferably has a smaller energy density than the laser beam being used to produce the microscopic fracture surfaces within the impingement area.

The laser beam is preferably guided in steps along the base surface in the impingement area. The irradiation of the base surface in the impingement area in this case takes place in successive steps, one exposure zone of the base surface being impinged upon with laser radiation, in each case. The individual exposure zones may overlap. The main body absorbs laser radiation in the exposure zones. This leads to locally limited areas with thermal stresses, which lead, in the brittle material of the main body, to cracks and to microscopic particles breaking free.

It is advantageous if the base surface in the impingement area is heated at points by means of the laser beam. The individual exposure zones, in which the main body absorbs laser radiation, in this case only have a very small extent, for example an extent of less than 1 mm, in particular less than 0.5 mm, preferably a maximum of 0.1 mm. Owing to the very small, practically punctiform extent of the exposure zones, deep damage to the main body due to the laser radiation can easily be avoided.

In a preferred embodiment, a focussed laser beam is guided along the base surface in a punctiform or linear manner in the impingement area. As a result, on the base surface, a roughened structure can be achieved, which is punctiform or linear and only extends over a part area of the base surface. The base surface therefore has roughened and non-roughened areas. The ratio between the roughened and non-roughened surface areas influences the adhesive force that can be achieved and thus provides the possibility of controlling the desired adhesive force so that, on the one hand, during an orthodontic treatment, directional forces can be reliably and reproducibly exerted on the tooth, and in that, on the other hand, the orthodontic element can be detached from the tooth once the treatment has ended, without there being a great risk of damage to the tooth enamel.

The orthodontic element may, for example, form a bracket or else a buccal or lingual tube.

It is particularly advantageous if the laser beam is repeatedly guided along the base surface in a punctiform or linear manner in the impingement area with exposure zones which completely or partially overlap one another. Depending on how often the laser beam is directed onto an exposure zone already impinged upon by the laser, the depth and the lateral width of the roughened structure can be influenced. By repeatedly passing the laser beam over the same exposure zone of the base surface, a depth structure can be achieved; in other words, in areas, from which microscopic particles have already been broken free, further particles can be broken free, without the main body thereby undergoing deep damage. Rather, the base surface in the impingement area is only heated at points and superficially by means of the laser radiation to a temperature below the melting temperature of the main body, so microscopic particles only detach superficially from the base surface.

The focus diameter of the laser beam being used in the impingement area, in an advantageous embodiment of the method according to the invention, is a maximum of 0.5 mm, in particular a maximum of 0.1 mm. For example, the focus diameter may be 0.02 mm to 0.09 mm.

It is favourable if the laser beam being used in the impingement area has an energy of a maximum of 20 W. In particular an energy in the range from 5 W to 15 W has proven to be advantageous. It may, for example, be provided that the laser beam has an energy of 10 W. If the laser beam is too powerful, this may lead to deep damage to the main body. In order to avoid deep damage of this type, the energy of the laser beam is advantageously limited. In order to nevertheless achieve a depth structure, the laser beam, as already mentioned, can be repeatedly guided along the base surface with exposure zones completely or partially overlapping one another.

The exposure time of the laser beam on an exposure zone, in an advantageous embodiment of the method, is a maximum of 0.5 s, in particular a maximum of 0.1 s. The exposure time of the laser beam influences the depth of the exposure zone. In order to avoid deep damage to the main body, the exposure time is advantageously limited.

The laser beam is pulsed in an advantageous embodiment.

The pulse width of the laser beam is advantageously a maximum of 0.1 μs, in particular a maximum of 50 ns.

A solid-state laser, in particular a neodymium-ytterbium-vanadate laser or a neodymium-YAG laser, is preferably used to irradiate the base surface in the impingement area.

The wavelength of the laser radiation being used in the impingement area, in an advantageous embodiment of the method according to the invention, is in the range from 800 nm to 1400 nm, in particular in the range from 1000 nm to 1200 nm. Short-wavelength infrared radiation is therefore preferably used. This is absorbed by the ceramic material of the main body, so that heating zones occur, in which microscopic particles detach owing to the induced crack formation.

In an advantageous embodiment of the method according to the invention, the main body is heated after the laser impingement of the impingement area. The retrospective heating allows remaining mechanical stresses to be reduced. The retrospective thermal treatment of the main body therefore leads to a curing of induced stresses.

It may be provided that the main body is a green body pressed from a ceramic powder material or an injection-moulded green body produced by ceramic injection moulding or a pre-sintered white body produced in the manners described, the base surface of which is impinged upon by the laser beam in the impingement area, and that the green body or white body is then sintered or hot isostatically pressed. The achievement of a roughened structure with a large number of fracture surfaces on the base surface of the main body can therefore take place during the production of the orthodontic element if the main body is present in the form of a green body or pre-sintered white body. Only after the laser irradiation is the main body then sintered or hot isostatically pressed. Pressing methods of this type for producing dental parts are known to the person skilled in the art from DE 10 2005 045 698 A1.

Alternatively, it may be provided that during the laser irradiation of the impingement area, the main body is a shaped body dense sintered from a ceramic powder material. The base surface of the main body, in a configuration of this type of the production method according to the invention, is then only impinged upon by the laser beam in the impingement area when the main body has already been sintered. The base surface of the dense sintered main body then undergoes a considerable surface area increase owing to the laser radiation, which leads to an improved adhesive strength, as was described above.

The main body is preferably manufactured from an oxide ceramic, in particular from aluminium oxide or zirconium oxide.

### BRIEF DESCRIPTION OF THE SEVERAL VIEWS OF THE DRAWINGS

The following description of a preferred embodiment of the invention is used for closer explanation in conjunction with the drawings, in which:

FIG. 1: shows a perspective view of an orthodontic element in the form of a bracket;

FIG. 2: shows an enlarged surface area of the base surface of the bracket from FIG. 1 with a roughened structure;

FIG. 3: shows a detail of the roughened structure from FIG. 2, more greatly enlarged;

FIG. 4: shows an enlarged detail from FIG. 3.

### DETAILED DESCRIPTION OF THE INVENTION

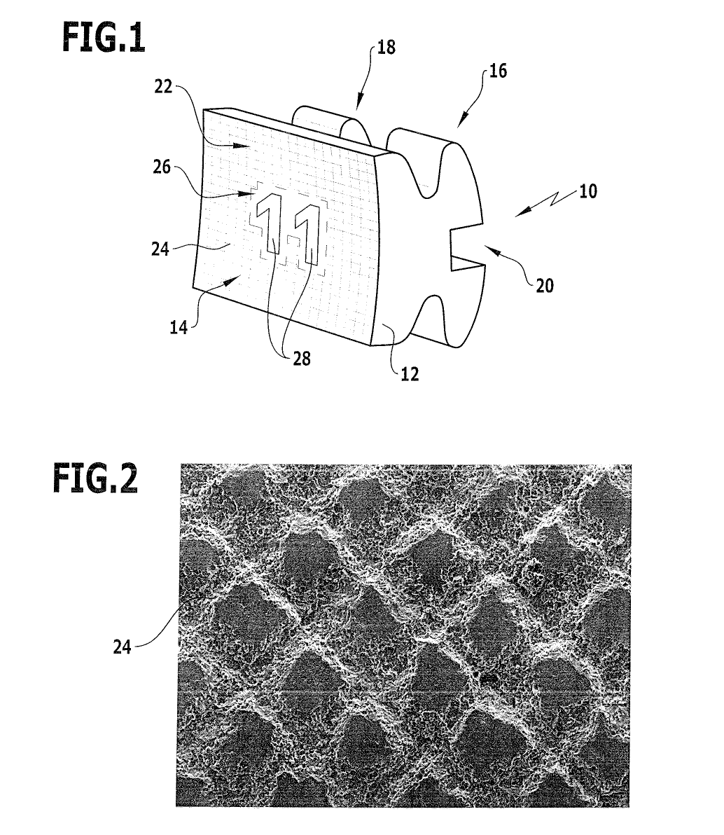

FIG. 1 schematically shows an orthodontic element in the form of a bracket 10, which in the conventional manner has a main body 12, which, on its rear face, forms a base surface 14 and, on its front face, carries a first wing pair 16 and a second wing pair 18 only incompletely shown in the drawing. The two wing pairs 16, 18 each have an occlusal-side wing and a gingival-side wing and are arranged at a spacing from one another. The wings delimit a slot 20 which runs in the mesial-distal direction and extends from the mesial side to the distal side of the bracket 10. The slot 20 is used in the conventional manner to receive an arch wire, which is known per se and therefore not shown in the drawing.

The base surface 14 comprises an impingement area 22, with a net-like roughened structure 24 and a residual area 26, which is surrounded by the impingement area 22 and in which a marking 28 is arranged in the form of a numerical abbreviation of the tooth type, to which the bracket 10 is allocated. In the embodiment shown, the bracket 10 in the residual area 26 of the base surface 12 carries the number sequence “11” as the marking. The marking 28 differs visually from the remaining area of the residual area 26 and also from the impingement area 22; the marking 22 is in particular lighter than the remainder of the base surface 14.

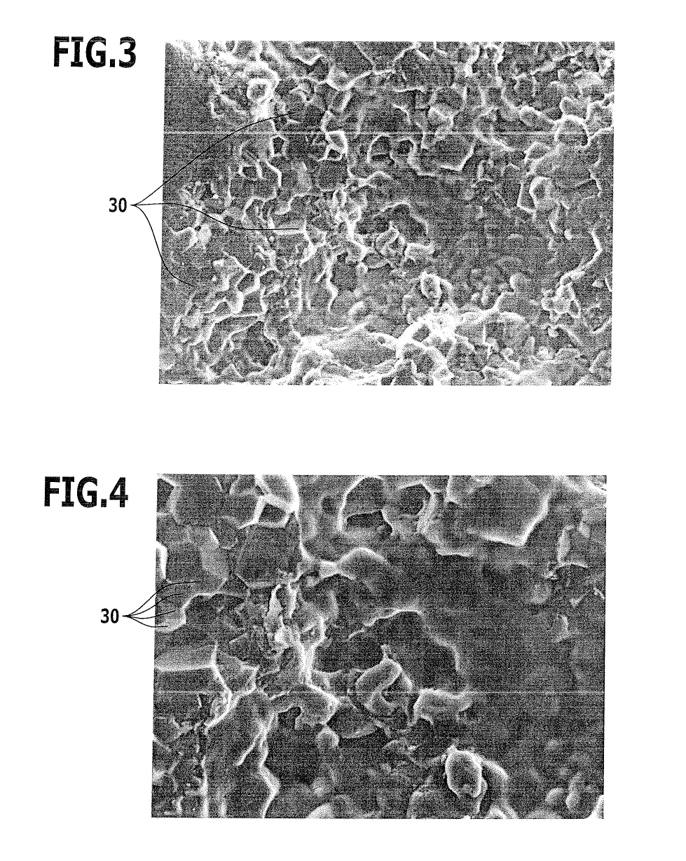

The bracket 10 can be glued to a tooth by its base surface 14. In order to achieve as stable an adhesive bond as possible between the bracket 10 and the tooth, the base surface 14 has the roughened structure 22, which is net-like in configuration in the embodiment shown. As becomes clear, in particular from the enlargements of the roughened structure in FIGS. 3 and 4, the roughened structure comprises a large number of flat fracture surfaces 30, which are oriented obliquely with respect to one another and lead to a considerable increase of the surface area of the base surface 14 and thereby improve the adhesive strength of the bracket 10 on the tooth.

The maximum extent of the fracture surfaces 30 is less than 50 μm. In the bracket 10 shown, the maximum extent of the fracture surfaces 30 is less than 20 μm.

In the embodiment shown, the entire bracket 10 including the main body 12 is manufactured from an oxide ceramic, for example from aluminium oxide. To produce the bracket 10, the oxide ceramic is provided in the form of a powder material, which is then pressed or injection-moulded to form a green body. It may be provided that the green body is pre-sintered to form a white body. In the impingement area 22, a focussed laser beam, in particular the beam of a solid-state laser, preferably a neodymium-ytterbium-vanadate laser, is then guided in steps along the base surface 14 of the green body or white body, the base surface 14 being superficially heated at points in the impingement area 22 by means of the laser beam to a temperature below the melting temperature of the oxide ceramic. Because of the local heating, thermal stresses are induced, which lead to a crack formation, so that microscopic particles are broken free from the base surface 14. The laser beam is pulsed and has a wavelength in the short-wave infrared range. In particular, the laser beam may have a wavelength of 1064 nm. The pulse width of the pulsed laser beam is less than 40 ns, and the energy of the laser beam is a maximum of 10 W. The focus diameter of the laser beam is less than 0.1 mm; it is preferably in the range from 40 to 80 μm. After the microscopic particles have broken free, the base surface 14 in the impingement area 22 exhibits the fracture surfaces 30, which are oriented obliquely with respect to one another and roughen the base surface 14.

In the impingement area 22, in order to achieve the roughened structure 22, the laser beam is repeatedly guided along the base surface 14 in a punctiform or linear manner with exposure zones which completely or partially overlap one another. It may, for example, be provided that the laser beam is guided 5 times or 10 times over the same exposure zones. This results in the fact that microscopic particles are broken free again from surface areas, from which microscopic particles have already been broken free. As a result, undercuts are also formed. The extent of the surface area increase and the number of undercuts are determined by the power of the laser beam, by the respective exposure time and by the number of laser impingements. The depth of the roughened structure 22 and its lateral width may, in particular, also be easily controlled by the number of laser impingements.

Owing to the breaking free of microscopic particles from the base surface 14 by means of the laser radiation guided along the base surface 14 in steps in the impingement area 22, a very good adhesive bond can be achieved between the bracket 10 and an adhesive, which is used to fix the bracket 10 to the tooth. The variation in the adhesive values is significantly reduced in comparison to the conventional silanisation of the base surface 14. The risk of a pre-damaged tooth enamel being destroyed at the end of an orthodontic treatment when the bracket 10 is detached from the tooth, is less than in silanised base surfaces.

As already described, the impingement area 22 in the embodiment shown only extends over a part area of the base surface 14. The base surface 14 may, however, also be treated in the residual area 26 with the laser beam in order to produce the marking 28. In particular, it may be provided that the laser beam being used to produce the roughened structure 22 is also used to produce the marking 28. However, the laser beam for producing the marking 28 is defocussed, so it has a smaller energy density than during the production of the roughened structure 22. Moreover, the laser beam to produce the marking 30 is moved continuously over the base surface 14.

Once the laser impingement of the base surface 14 has taken place, the main body 14 present as a green body or white body can be sintered or hot isostatically pressed.

Alternatively it may be provided that the main body 12 is already a shaped body dense sintered from a ceramic powder material before the impingement of the base surface 14 with the laser radiation, in other words, it may be provided that the main body 12 is firstly sintered or hot isostatically pressed before the base surface 14 is impinged upon with laser radiation to achieve the roughened structure 22 and to produce the marking 30. The use of the laser beam in an open-porous fired or green main body has the advantage, however, that owing to the subsequent thermal treatment, in other words owing to the sintering or the hot isostatic pressing, thermal stresses introduced by the laser irradiation can be compensated.

1. A method for producing an orthodontic element with a ceramic main body, which has a base surface for fixing the element to a tooth, the method comprising: guiding a laser beam along the base surface of the ceramic body in an impingement area, so that the base surface in the impingement area is superficially heated locally by the laser beam and microscopic particles are broken free from the base surface by means of crack development.

2. The method according to claim 1, wherein the impingement area extends only over a partial area of the base surface.

3. The method according to claim 2, including marking the base surface outside the impingement area for allocating the orthodontic element to a tooth type.

4. The method according to claim 3, wherein the marking is produced by a laser beam.

5. The method according to claim 1, including guiding the laser beam in steps along the base surface in the impingement area.

6. The method according to claim 1, including heating the base surface at points in the impingement area by the laser beam.

7. The method according to claim 1, including guiding a focussed laser beam along the base surface in a punctiform or linear manner in the impingement area.

8. The method according to claim 1, wherein in the impingement area, the laser beam is repeatedly guided along the base surface in a punctiform or linear manner with exposure zones which completely or partially overlap one another.

9. The method according to claim 1, wherein the laser beam has a focus diameter in the impingement area of a maximum of 0.5 mm.

10. The method according to claim 1, wherein the laser beam being used in the impingement area has an energy of a maximum of 20 W.

11. The method according to claim 1, wherein the laser beam being used in the impingement area on a punctiform exposure zone has an exposure time of a maximum of 0.5 s.

12. The method according to claim 1, wherein the laser beam being used in the impingement area is pulsed.

13. The method according to claim 12, wherein the laser beam has a pulse width of a maximum of 0.1 μs.

14. The method according to claim 1, wherein a solid-state laser is used to irradiate the base surface in the impingement area.

15. The method according to claim 1, wherein the laser beam being used in the impingement area has a wavelength of in the range from 800 nm to 1400 nm.

16. The method according to claim 1, further comprising heating the main body after the laser impingement of the impingement area of the base surface.

17. The method according to claim 1, wherein the main body is a green body pressed or injection-moulded from a ceramic powder material or a presintered white body, the base surface of which is impinged upon in the impingement area by the laser beam, and wherein the method further comprises sintering or hot isostatically pressing the green body or white body.

18. The method according to claim 1, wherein the main body is a shaped body dense sintered from a ceramic powder material.

19. The method according to claim 9, wherein the laser beam has a maximum focus diameter in the impingement area of 0.1 mm.
